(19) United States
(12) Patent Application Publication
(10) Pub. No.: US 2018/0290143 A1
(43) Pub. Date: Oct. 11, 2018

(54) VESSEL CARRIER FOR AN AUTOMATED ANALYSIS SYSTEM

(71) Applicant: Roche Diagnostics Operations, Inc., Indianapolis, IN (US)

(72) Inventors: Marco Cofano, Rotkreuz (CH); Ivo Eugster, Rotkreuz (CH); Marco Sangermano, Rotkreuz (CH)

(73) Assignee: Roche Diagnostics Operations, Inc., Indianapolis, IN (US)

(21) Appl. No.: 15/939,349

(22) Filed: Mar. 29, 2018

(30) Foreign Application Priority Data
Apr. 5, 2017 (EP) 17165075.7

(51) Int. Cl. B01L 9/06; G01F 23/26; G01N 35/10; G01N 35/04

(52) U.S. Cl. CPC B01L 9/06; G01F 23/266; B01L 2200/028; G01N 35/04; G01N 2035/0401; G01N 35/1011

(57) ABSTRACT

A vessel carrier for use in an automated laboratory system is disclosed. The vessel carrier comprises an upper side, a bottom side, and a middle body portion between the upper side and the bottom side. The upper side comprises openings for introducing vessels. The middle body portion comprises vessel holding positions comprising walls for holding a vessels and extending in correspondence to the openings on the upper side into the middle body portion. The vessel carrier further comprises a two-component structure comprising a core component made of electrically conductive material. The core component comprises part of the bottom side and the walls of the vessel holding positions. The vessel carrier further comprises a cover component covering part of the core component and is made of a material that is different or has different properties with respect to the material of the core component and is customizable for identification and/or handling.

### CROSS-REFERENCE TO RELATED APPLICATIONS

This application claims priority to EP 17165075.7, filed Apr. 5, 2017, which is hereby incorporated by reference.

### BACKGROUND

The present disclosure relates to a vessel carrier and to an automated laboratory system comprising the vessel carrier.

Automated laboratory systems for in-vitro diagnostics typically require precise pipetting of test fluids in order to maintain satisfactory analytical accuracy. Usually, pump-controlled aspiration probes are used for aspirating and discharging fluids. In order to minimize the danger of cross-contamination and facilitate probe cleaning, it is desirable to position the probe tip just below the fluid surface of a test fluid contained in a vessel. The test fluid can either be aspirated while keeping the probe stationary or, in case of larger volumes, while lowering the probe further into the vessel so as to maintain the probe tip in the test fluid.

In many cases, fluid levels can greatly vary from one vessel to another so that the probe tip has to be reliably positioned within the fluid before starting any pipetting operation. Hence, it is customary for many applications to detect the fluid level of a test fluid for positioning of the probe.

As known in the art, fluid level detection can be based on various physical principles such as detecting light reflected from the fluid surface or measuring electric characteristics of a probe when put in contact with the fluid. However, in some cases, especially in the case of fluids which are likely to be subject to foam formation and/or in presence of a pierceable septum closing the vessel, the reliability of results obtained by conventional fluid level detection techniques can be unacceptably low. For example, when using a technique based on the change of an electric capacitance of the probe, it is likely to occur that in the case foam is present on the surface of a test fluid the foam causes a capacitance change similar to that one of the fluid so that there is no clear discrimination between fluid and foam. Similarly, if test liquid, e.g. in form of droplets is present underneath a closure closing the vessel, this may generate a false signal. Accordingly, there is a risk that air rather than test fluid is aspirated, resulting in undesired pipetting errors.

Methods based on measuring a change of electric resistance can be more reliable in determining fluid level even in presence of foam and/or a closure.

Normally, vessels containing the test fluids are held by vessel carriers during pipetting and during fluid level detection.

In order to measure changes of electric resistance with higher accuracy and precision, the vessel carrier has to be electrically conductive and in contact with an electric ground.

Vessel carriers usually carry a color code for conveniently distinguishing a type of vessel carrier from another vessel carrier having the same shape and dimension but a different use. For example, a vessel carrier may be dedicated to vessels containing test samples. Another vessel carrier may be dedicated to vessels containing control samples, another to vessels containing calibration samples, and so on. Thus vessel carriers may have different colors or carry labels of different colours or other distinguishing marks that are easily recognized. Also, vessel carriers typically carry one or more labels, e.g. a barcode or other identification tag, or markings for e.g. identifying the particular vessel carrier or indirectly the vessel or vessels or type of vessels carried by the vessel carrier, or positioning markings for defining the position of individual vessels on a vessel carrier.

In order to make a vessel carrier electrically conductive, a metal such as for example steel or aluminium could be used. This would make manufacturing costs higher, would increase also the weight and reduce the handling performance of the vessel carriers.

Polymeric materials containing high concentrations of carbon fibers can be also used. The carbon fibers make however the material black which remains the dominant color even when mixing with other pigments. Although plastic materials with low conductivity are available in different colors, the electrical conductivity of these is typically insufficient for fluid level detection. Thus it is not easy to produce vessel carriers of different colours that are sufficiently electrically conductive. Another problem of such materials is that they are mechanically not very resistant and as such subject to deformation. Also they are not very suitable for being injection molded. Extrusion is a preferred method, but this is less precise than injection molding and not suitable for every shape. These materials show low surface bonding performance and are also not very suitable for attaching labels or for laser marking. Also, coating or plating or painting a product made with such a material is not durable and moreover it is also expensive.

The advantage of electrical conductivity typical of polymeric materials containing high concentrations of carbon fibers is therefore counterbalanced by several disadvantages.

Therefore, there is a need for an inexpensive vessel carrier that is not only electrically conductive but is also customizable for identification and/or handling, e.g. by color coding and/or by allowing labels to be attached and/or by enabling marking and that is also more resistant to mechanical stress, temperature stress and washing conditions and is therefore more durable.

### SUMMARY

According to the present disclosure, a vessel carrier for use in connection to an automated laboratory system is presented. The vessel carrier can comprise an upper side comprising one or more openings for introducing a respective number of vessels, a bottom side, and a middle body portion between the upper side and the bottom side. The middle body portion can comprise one or more vessel holding positions comprising walls for holding a respective number of vessels and extending respectively in correspondence to the one or more openings on the upper side into the middle body portion. The vessel carrier can also comprise a two-component structure comprising a core component made of an electrically conductive material. The core component can comprise at least part of the bottom side and the walls of the one or more vessel holding positions. The two-component structure can also comprise a cover component that covers at least part of the core component and is made of a material that is different or has different properties with respect to the material of the core component and is customizable for identification and/or handling.

In accordance with one embodiment of the present disclosure, an automated laboratory system is presented. The automated laboratory system can comprise an analyzer for analyzing biological samples and an above vessel carrier carrying one or more vessels in contact with the walls of the vessel holding positions of the core component. The vessels can contain test fluids such as biological samples to be analyzed or reagents to be used with the biological samples or mixtures of biological sample and reagents.

Accordingly, it is a feature of the embodiments of the present disclosure to provide an inexpensive vessel carrier that is not only electrically conductive but is also customizable for identification and/or handling, e.g. by color coding and/or by allowing labels to be attached and/or by enabling marking and that is also more resistant to mechanical stress, temperature stress and washing conditions and is therefore more durable. Other features of the embodiments of the present disclosure will be apparent in light of the description of the disclosure embodied herein.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates a first example of vessel carrier according to an embodiment of the present disclosure.

FIG. 2 illustrates a second example of vessel carrier according to an embodiment of the present disclosure.

FIG. 3 illustrates an exploded view of the vessel carrier of FIG. 1 according to an embodiment of the present disclosure.

FIG. 4 illustrates the same components of FIG. 3 during assembly according to an embodiment of the present disclosure.

FIG. 5 illustrates schematically an automated laboratory system according to an embodiment of the present disclosure.

FIG. 6 illustrates an example of a transport mechanism for moving a vessel carrier according to an embodiment of the present disclosure.

### DETAILED DESCRIPTION

In the following detailed description of the embodiments, reference is made to the accompanying drawings that form a part hereof, and in which are shown by way of illustration, and not by way of limitation, specific embodiments in which the disclosure may be practiced. It is to be understood that other embodiments may be utilized and that logical, mechanical and electrical changes may be made without departing from the spirit and scope of the present disclosure.

A vessel carrier for use in connection to an automated laboratory system is introduced. The vessel carrier can comprise an upper side, a bottom side and a middle body portion between the upper side and the bottom side. The upper side can comprise one or more openings for introducing a respective number of vessels. The middle body portion can comprise one or more vessel holding positions comprising walls for holding a respective number of vessels and extending into the middle body portion in correspondence to the one or more openings on the upper side respectively. The vessel carrier can also comprise a two-component structure comprising a core component and a cover component. The core component can comprise at least part of the bottom side and the walls of the one or more vessel holding positions and can be made of an electrically conductive material. The cover component can cover at least part of the core component and can be made of a material that is different or has different properties with respect to the material of the core component and can be customizable for identification and/or handling.

An automated laboratory system is also disclosed comprising an analyzer for analyzing biological samples and a vessel carrier carrying one or more vessels in contact with the walls of the vessel holding positions of the core component. The vessels can contain test fluids such as biological samples to be analyzed or reagents to be used with the biological samples or mixtures of biological samples and reagents.

The term “test fluid” can be herein generally used to indicate a fluid subject to an in-vitro diagnostic test. Such a fluid may be either a test sample, including, e.g. a control sample or a calibrator, or a reagent, or a mixture of a test sample and one or more reagents.

The term “test sample” can refer to a biological material suspected of containing one or more analytes of interest and whose detection, qualitative and/or quantitative, may be associated to a clinical condition. The test sample can be derived from any biological source, such as a physiological fluid, including blood, saliva, ocular lens fluid, cerebral spinal fluid, sweat, urine, milk, ascites fluid, mucous, synovial fluid, peritoneal fluid, amniotic fluid, tissue, cells or the like. The test sample can be pretreated prior to use, such as preparing plasma from blood, diluting viscous fluids, lysis or the like; methods of treatment can involve filtration, centrifugation, distillation, concentration, inactivation of interfering components, and the addition of reagents. A test sample may be used directly as obtained from the source in some cases or following a pretreatment and/or sample preparation workflow to modify the character of the sample, e.g. after adding an internal standard, after being diluted with another solution or after having being mixed with reagents e.g. to enable carrying out one or more in vitro diagnostic tests, or for enriching (extracting/separating/concentrating) analytes of interest and/or for removing matrix components potentially interfering with the detection of the analyte(s) of interest.

A “reagent” can be a substance used for treatment of a test sample in order, e.g., to prepare a test sample for analysis, to enable a reaction to occur, or to enable detection of a physical parameter of the test sample or analyte contained in the test sample. In particular, a reagent can be a substance that is or comprises a reactant, typically a compound or agent capable e.g. of binding to or chemically transforming one or more analytes present in a test sample or an unwanted matrix component of the test sample. Examples of reactants are enzymes, enzyme substrates, conjugated dyes, protein-binding molecules, ligands, nucleic acid binding molecules, antibodies, chelating agents, promoters, inhibitors, epitopes, antigens, and the like. However, the term reagent is used to include any fluid that can be added to a test sample including a dilution liquid, including water or other solvent or a buffer solution, or a substance that can be used for disruption of specific or nonspecific binding of an analyte to a protein, binding proteins or surfaces.

The term “vessel” can be herein used to indicate a container comprising a body and an inner space adapted to receive a test fluid. Thus, the vessel may be a test sample container, a reagent container or a reaction vessel, e.g. a cuvette.

According to an embodiment, the vessel can be a test sample tube. A “test sample tube” can either be a sample collection test tube, also called “primary tube”, which can be used to receive a test sample such as a blood sample from a patient and to transport the test sample contained therein to an analytical laboratory, or a “secondary tube”, which may be used to receive an aliquot of the test sample from a primary tube. A primary sample tube can typically be made of glass or plastics, can have a closed end and an open end that may be closed by a closure. A secondary tube can typically be made of plastics and may have a different size and shape with respect to primary tubes. In particular, secondary tubes may be smaller than primary tubes and be designed to be closed with one type or similar types of closure.

The term “closure” can be herein used to indicate any type of cap, comprising screw-type caps and rubber stoppers, which can be opened and/or closed by a pulling/pushing and/or screwing motion respectively.

A “vessel carrier” can be a device comprising one or more vessel holding positions configured to receive and hold a respective number of vessels. In particular, the vessel carrier may be a single vessel carrier, also called “puck”, comprising only one vessel holding position for carrying one vessel at a time, or a multi-vessel carrier, also called “rack”, comprising a plurality of vessel holding positions arranged e.g. in a one-dimensional or two-dimensional array.

According to an embodiment, the vessel carrier can be a test sample tube carrier such as a single-tube carrier or a tube rack.

A “vessel holding position” can be a hollow space extending into the middle body portion of the vessel carrier delimited by lateral walls of appropriate geometry, e.g. a cylindrical wall, by an opening at the upper side of the vessel carrier and possibly by a closed bottom, configured in size and shape, e.g. in cross-section or diameter and depth, to receive at least a lower portion of a vessel and to hold the vessel in an upright position. The geometry of the walls and possibly bottom of the vessel holding position can typically reflect the geometry of the walls of the vessel. Ideally, the geometry of the vessel holding position can be form fit with at least a portion of the geometry of the vessel such as to maximize the surface of contact between the vessel and the walls of the vessel holding position. However, the walls may not need to be continuous as long as capable of holding a vessel in position. The walls may comprise for example a window for enabling reading of a label attached to the vessel. The vessel holding position may also comprise additional features such as one or more resilient members or inserts that contribute to hold a vessel in a centered and upright positing within the vessel holding position.

The vessel carrier can comprise a two-component structure comprising a core component and a cover component. The core component can comprise at least part of the bottom side of the vessel carrier and at least part of the middle body portion of the vessel carrier comprising the walls of the one or more vessel holding positions. The core component can be made of an electrically conductive material.

A suitable electrically conductive material can have an electrical conductivity below 10⁻⁴ Ohm meter (Ω m), preferably below 10⁻⁶ Ω m, or a surface (sheet) resistance below 10⁴ Ohm, preferably below 10² Ohm, when measured at ambient conditions. Examples of such electrically conductive materials can be metals such as aluminum, copper, silver, carbon and polymers containing dispersions of conductive materials, e.g. carbon, e.g. in the form of carbon fibers. The list is not exhaustive.

According to certain embodiments, the electrically conductive material forming the core component can be a metal or an electrically conductive polymeric material.

According to an embodiment, the electrically conductive polymeric material can comprise a mixture of polymer, e.g. polypropylene, and carbon fiber at a dosage of at least 70% (mixed with additional polymer, e.g. non-conductive polypropylene, to make up 100%) and preferably at a dosage of 100% (without dilution).

The higher the dosage, the higher the electrical conductivity is. Moreover, at higher dosages, or better at 100% dosage, a more homogeneous distribution of the carbon fiber content can be obtained, thereby resulting in a more homogenous electrical conductivity across the core component, particularly between different vessel holding positions.

In alternative to polypropylene, other polymers may be used such as polyethylene, polystyrene, acrylonitrile butadiene styrene (ABS), polyurethane, polyolefin elastomer and polyvinyl chloride (PVC).

According to an embodiment, the electrically conductive polymeric material can have a surface (sheet) electric resistance that is less than 4000 Ohm and, typically, less than 2000 Ohm.

The cover component can cover at least part of the core component and can be made of a material that is different or has different properties with respect to the material of the core component and can be customizable for identification and/or handling.

The term “customizable for identification and/or handling” can mean that the material of the cover component can be more suitable than the material of the core component for design customization that enables identification of a particular vessel carrier and/or appropriate handling. The term “design customization” can include visual or machine-readable characterization that can help distinguish between different vessel carriers. The visual or machine readable characterization may include color, or other surface properties, such as shading, reflectance and hardware coding, labeling (surface bonding) or surface marking. Design customization may include also manufacturing properties, e.g. suitability to be injection molded, and durability, e.g. resistance to mechanical stress, temperature stress and washing conditions.

According to an embodiment, the cover component can be made of a non-electrically-conductive polymer, for example polypropylene or similar material with comparable mechanical and surface properties.

According to an embodiment, the cover component can comprise any one or more of a carrier identification label or marking, vessel position label or marking, carrier-type label or marking. According to an embodiment, the marking can be a laser marking.

According to an embodiment, the core component can be formed as a first piece and the cover component can be formed as a separate second piece designed to form fit with the first piece, to be separable from the first piece and to be replaceable or exchangeable. One advantage of this embodiment can be that the number of different vessel carriers needed may be reduced if not used at the same time and manufacturing can also be facilitated.

According to an embodiment, the core component can be formed as a first piece and the cover component can be injection molded on top of the first piece to form an inseparable two-component structure together with the first piece.

Inseparable two-component structures may be however obtained also starting from two separately manufactures components, e.g. by permanently joining together the core component formed as a first piece and the cover component formed as a second piece, e.g. using gluing, temperature or ultrasound bonding.

An “automated laboratory system” can be an analytical apparatus dedicated to the analysis of test fluids for in vitro diagnostics. Examples of such analytical apparatuses can be clinical chemistry analyzers, coagulation analyzers, immunochemistry analyzers, hematology analyzers, urine analyzers and nucleic acid analyzers that are used for the qualitative and/or quantitative detection of analytes present in the test fluids, to detect the result of chemical or biological reactions and/or to monitor the progress of chemical or biological reactions. The analytical apparatus can comprise functional units for pipetting and/or mixing of samples and/or reagents. The analytical apparatus may comprise a reagent holding unit for holding reagent vessels to perform the analysis. Reagents may be arranged for example in the form of containers or cassettes containing individual reagents or group of reagents and placed in appropriate receptacles or positions within a storage compartment or conveyor. It may comprise a consumable feeding unit, e.g. for feeding reaction vessels. The analytical apparatus can further comprise one or more mixing units, comprising e.g. a shaker to shake a vessel containing a test fluid, or a mixing paddle to mix fluids in a vessel or reagent container. The analytical apparatus can further comprise a particular detection system and follow a particular workflow, e.g. execute a number of processing steps, which can be optimized for certain types of analysis, e.g. clinical chemistry, immunochemistry, coagulation, hematology, and the like.

The analytical apparatus may have different configurations according to the need and/or according to the desired laboratory workflow. Additional configurations may be obtained by coupling a plurality of apparatuses together and/or adding modules. A “module” can be a work cell, typically smaller in size and weight than an entire analytical apparatus, which can have an auxiliary function to the analytical function of an analytical apparatus and can work only together with an analytical apparatus. In particular, a module can be configured to cooperate with one or more analytical apparatuses for carrying out dedicated tasks of a sample processing workflow, which can occur for example before or after analysis of the test fluid, e.g. by performing one or more pre-analytical and/or post-analytical steps. Examples of the pre-analytical and/or post-analytical steps can be loading and/or unloading and/or transporting and/or storing test fluid vessels or vessel carriers carrying test fluid vessels, e.g. sample racks, loading and/or unloading and/or transporting and/or storing reagent vessels or vessel carriers carrying reagent vessels, e.g. reagent cassettes, loading and/or unloading and/or transporting and/or storing and/or washing reaction vessels, e.g. cuvettes, loading and/or unloading and/or transporting and/or storing pipette tips or tip racks, reading and/or writing information bearing labels, e.g. barcodes or RFID tags, washing pipette tips or needles or reaction vessels, e.g. cuvettes, mixing paddles, mixing of test fluids, e.g. biological samples with other fluid, e.g. reagents, solvents, diluents, buffers, decapping, recapping, pipetting, aliquoting, centrifuging, and so on. An example of such a module can be a loading and/or unloading unit for loading/unloading vessel carriers.

According to an embodiment, the automated laboratory system can comprise at least one aspiration probe having an electric capacitance, a positioning mechanism, adapted for moving the aspiration probe relative to a test fluid in a vessel held by a vessel carrier, a voltage source for charging the aspiration probe, and an electric drain in contact with the bottom side of the vessel carrier for discharging the aspiration probe when the aspiration probe contacts the test fluid by generating a discharging current passing from the aspiration probe to the electric drain though the test fluid, the vessel containing the test fluid and the core component of the vessel carrier. The automated laboratory system can further comprise an electric circuitry connected to the aspiration probe, adapted to measure the discharging current, a controller, configured to move the aspiration probe into the sample and to determine a level of the test fluid in the vessel based on the measured current.

The lower the electrical conductivity of the core component material of the vessel carrier is the more accurate the determination of the test fluid level can be. Thus, it can be preferred that the surface (sheet) electric resistance of the core component material be less than about 4000 Ohm in one embodiment. In another embodiment, the surface (sheet) electric resistance of the core component material can be less than about 2000 Ohm. In yet another embodiment, the surface (sheet) electric resistance of the core component material can be less than about 1000 Ohm.

According to an embodiment, the automated laboratory system can further comprise a reading device for reading an identification label or marking on the cover component of the vessel carrier.

According to an embodiment, the automated laboratory system can further comprise a transportation system for moving the vessel carrier. The transportation system may comprise a transportation band or a magnetic transportation path or a push/pull mechanism or a shuttle mechanism or a gripping robotic arm or similar transportation mechanism arranged such that a vessel carrier can be moved for bringing a vessel at a time in correspondence to the aspiration probe.

According to an embodiment, the bottom side of the vessel carrier can comprise an engagement element for engaging with a transport element of the transportation mechanism of the automated laboratory system for moving the vessel carrier. The engagement element may be part of the core component or the cover component. According to an embodiment, the core component of the vessel carrier can be magnetic or paramagnetic for enabling magnetic transport of the vessel carrier.

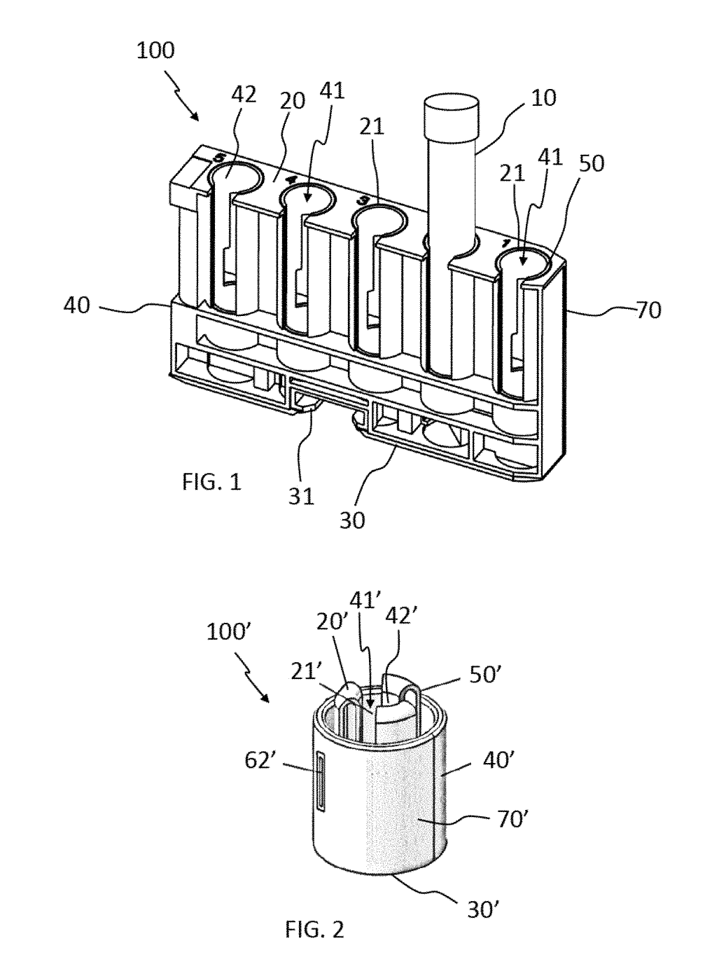

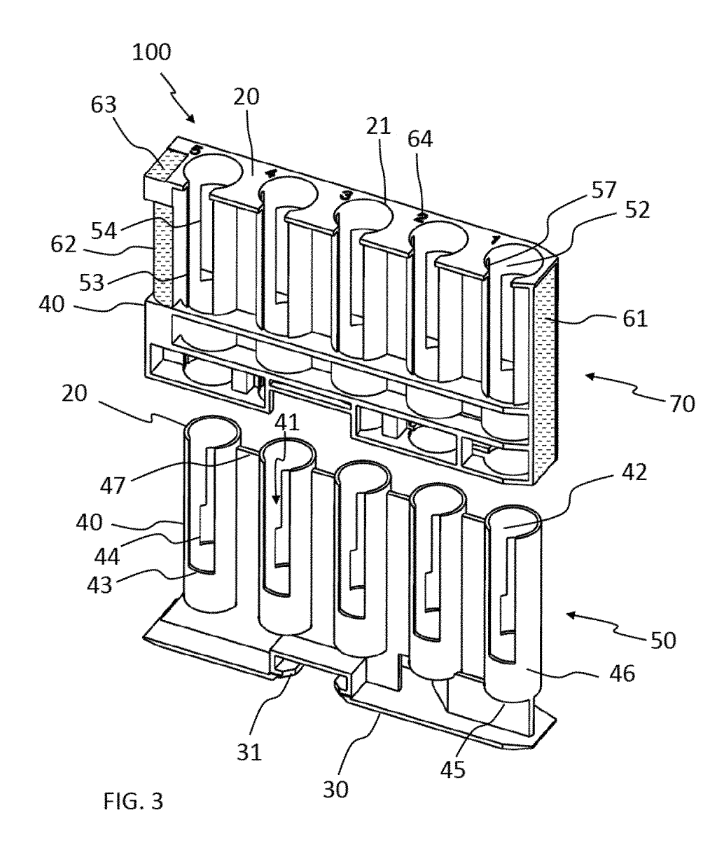

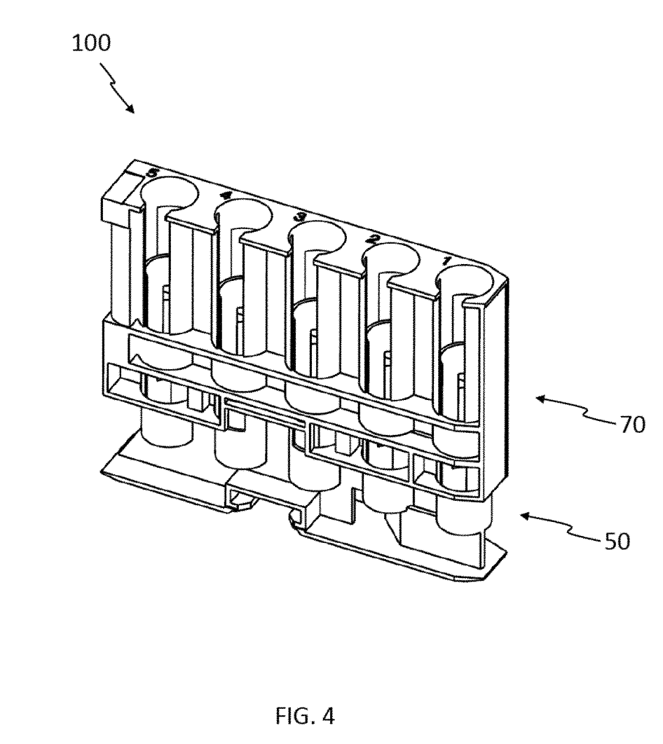

Referring initially to FIG. 1, FIG. 1 shows a vessel carrier 100 according to a first embodiment. The vessel carrier 100 can comprise an upper side 20, a bottom side 30 and a middle body portion 40 between the upper side 20 and the bottom side 30. The upper side 20 can comprise a plurality of openings 21 for introducing a respective number of vessels 10 (only one shown in FIG. 1). The middle body portion 40 can comprise a plurality of, in this case five, vessel holding positions 41 comprising walls 42 for holding a respective number of vessels 10 and extending into the middle body portion 40 in correspondence to the openings 21 on the upper side 20 respectively. The vessel carrier 100 can comprise a two-component structure comprising a core component 50 and a cover component 70 shown in an exploded view in FIG. 3.

The core component 50 can be formed as a first piece and the cover component 70 can be formed as a separate second piece designed to form fit with the first piece, to be separable from the first piece, and to be replaceable or exchangeable. However, according to an alternative embodiment, the core component 50 and the cover component 70 may be permanently bonded together. According to yet another embodiment, the core component 50 can be formed as a first piece and the cover component 70 can be injection molded on top of the first piece to form an inseparable two-component structure together with the first piece.

With continued reference to FIG. 1 and FIG. 3, the core component 50 can comprise the bottom side 30 and the walls 42 of the vessel holding positions 41. In particular, the vessel holding positions 41 can be embodied as hollow cylinders 46 formed by the walls 42 and can be held together by intermediate ribs 47 in a single-piece structure together with the bottom side 30. The vessel holding positions 41 can further comprise a closed bottom 45 and a lateral aperture in the form of a window 43, through which a vessel 10 arranged in the vessel holding position can be seen, e.g. in order to read a label of the vessel 10. Reading the label of a vessel 10 may include rotating the vessel 10, e.g. by contacting the vessel 10 with a rotating wheel (not shown) through a second window 44 at the opposite side. The upper rim of the hollow cylinders 46 can be open and fit in the opening 21 to form part of the upper side 20.

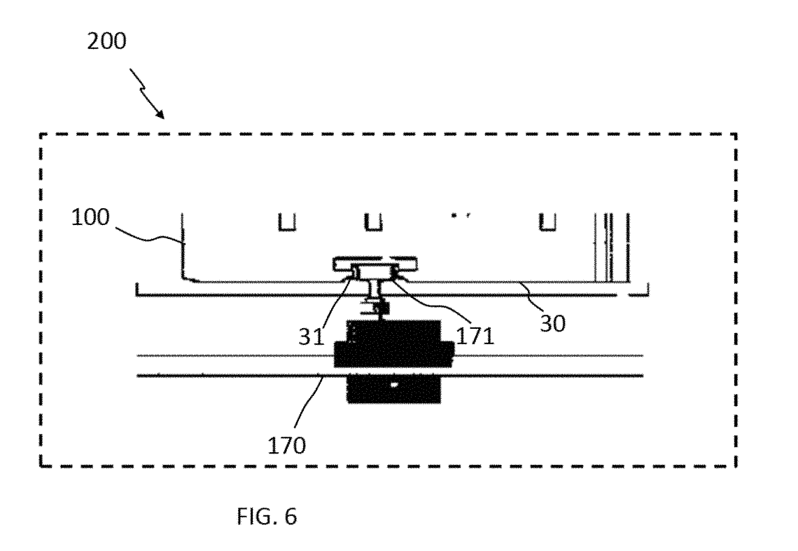

The bottom side 30 can comprise an engagement element 31, shaped as a recess, for engaging with a transport element, e.g. a pin, finger or the like, of an automated laboratory system for moving the vessel carrier 100 as shown in FIG. 6.

The core component 50 can be made of an electrically conductive material. In this example, the electrically conductive material can be a mixture of polypropylene and carbon fiber, such as currently commercially available from RTP Imagineering Plastics (Catalog No. RTP 0100 PP90025685) used as a concentrate at a dosage of 100%, and having a surface resistance of about 10 Ohm at this dosage. Any other electrically conductive material such as those mentioned above could be however used, including metal.

The cover component 70 can be made of a material having different properties with respect to the material of the core component 50 in order to be customizable for identification and/or handling. For example, it can be made of a non-electrically-conductive polymer such as polypropylene.

The interior of the cover component 70 can be designed to form fit with the exterior of core component 50, whereas the exterior can be customized according to the need and the particular use in connection to a laboratory automated system.

In particular, the respective middle body portions 40 can be designed to fit with each other. In particular, the cover component 70 can comprise cylindrical recesses 52, in correspondence to the openings 21, which can be complementary in shape to the outer surface of the walls 42 of the vessel holding positions 41. The cylindrical recesses 52 can further comprise slits 57 that can be complementary in shape to the intermediate ribs 47 and apertures 53, 54 that can be arranged to be in correspondence to the windows 43, 44 of the vessel holding positions 41 respectively.

This form fit design can be more greatly appreciated with reference to FIG. 4 showing the core component 50 and the cover component 70 during assembly.

With continued reference to FIG. 3, the cover component 70 can further comprise defined customizable zone 61, 62, 63, 64. One zone 62, for example, may be used for attaching a carrier identification label, e.g. a barcode or RFID tag, or for printing an identification marking directly on the surface. Other zones 64 may comprise vessel position markings, e.g. a number identifying each vessel holding position 41. Other zones 61, 63 may comprise a carrier-type label or marking, e.g. a color label or marking or other visual identification marking for distinguishing between vessel carriers 100 intended for different uses, either visually or automatically by machine recognition. The markings may be applied for example by laser marking technology as known in the art.

FIG. 2 shows another example of vessel carrier 100′. The vessel carrier 100′ can comprise an upper side 20′, a bottom side 30′ and a middle body portion 40′ between the upper side 20′ and the bottom side 30′. The upper side 20′ can comprise one opening 21′ for introducing one vessel 10 (not shown in FIG. 2). The middle body portion 40′ can comprise one vessel holding positions 41′ comprising walls 42′ for holding one vessel 10 and extending into the middle body portion 40 in correspondence to the opening 21′ on the upper side 20′. The vessel carrier 100′ can comprise a two-component structure comprising a core component 50′ and a cover component 70′.

The core component 50′ can be made of an electrically conductive material like the core component 50 of FIG. 1. According to an embodiment, the core component 50′ can be magnetic or paramagnetic for enabling magnetic transport of the vessel carrier. The cover component 70′ can be made of a material having different properties with respect to the material of the core component 50′ in order to be customizable for identification and/or handling. For example, it can be made of a non-electrically-conductive polymer such as polypropylene like the cover component 70.

Importantly, the core component 50′ can comprise the bottom side 30′ and the walls 42′ of the vessel holding position 41′. The cover component 70′ can comprise a customizable zone 62′ including a carrier identification label, e.g. a barcode or RFID tag, or an identification marking directly on the surface. Moreover, the entire surface of the cover component 70′ may be customized for identification, e.g. by using different colors for different uses.

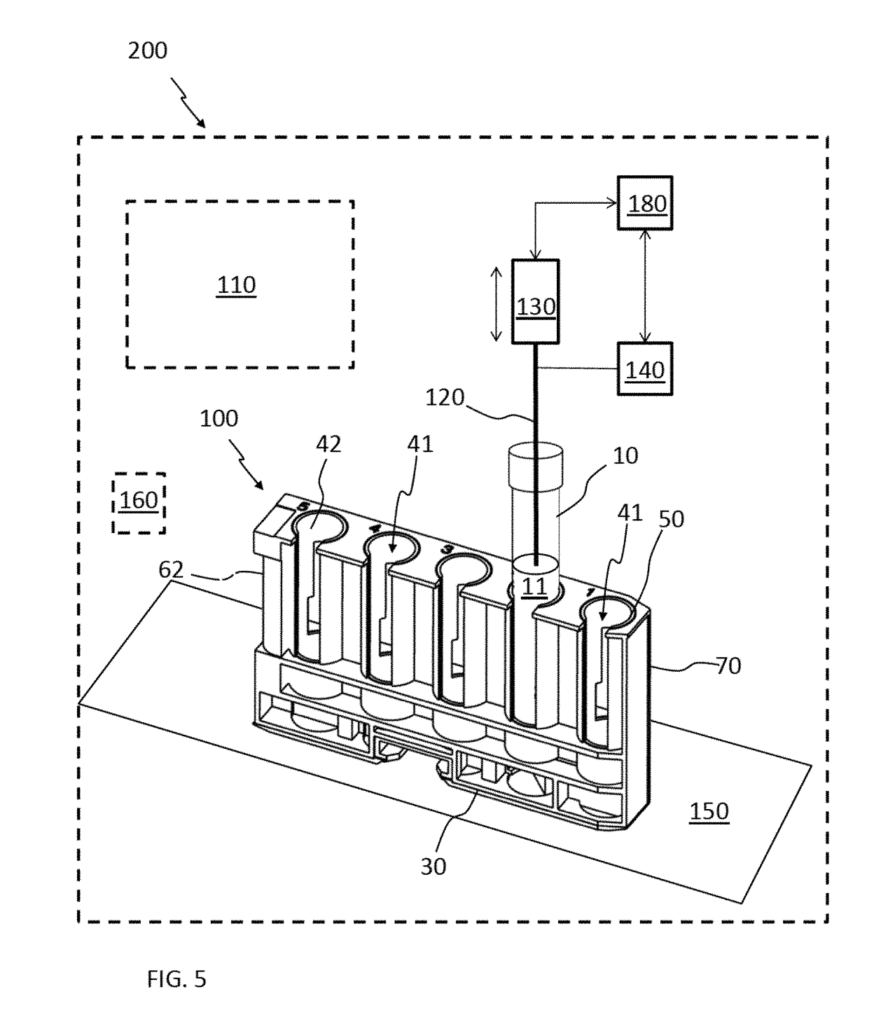

FIG. 5 shows schematically an automated laboratory system 200. The automated laboratory system 200 can comprise an analyzer 110 for analyzing biological samples and a vessel carrier 100 like that of FIG. 1 carrying a vessel 10 (only one shown for simplicity) in contact with the walls 42 of a vessel holding position 41 of the core component 50, the vessel 10 containing a test fluid 11 such as a biological sample to be analyzed. The automated laboratory system 200 may be configured to work in connection with a vessel carrier 100′ like in FIG. 2 as well.

The automated laboratory system 200 can further comprise an aspiration probe 120 having an electric capacitance, a positioning mechanism 130, adapted for moving the aspiration probe 120 relative to the test fluid 11 in the vessel 10, and a voltage source 140 for charging the aspiration probe 120.

The automated laboratory system 200 can further comprise an electric drain 150 in contact with the bottom side 30 of the vessel carrier 100 for discharging the aspiration probe 120 when the aspiration probe 120 contacts the test fluid 11 by generating a discharging current passing from the aspiration probe 120 to the electric drain 150 though the test fluid 11, the vessel 10 containing the test fluid 11 and the core component 50 of the vessel carrier 100, including walls 42 and bottom side 30.

The automated laboratory system 200 can further comprise an electric circuitry (not shown) connected to the aspiration probe 120, adapted to measure the discharging current, and a controller 180, configured to move the aspiration probe 120 into the test fluid 11 and to determine a level of the test fluid 11 in the vessel 10 based on the measured current.

The automated laboratory system 200 can further comprise a reading device 160 for reading an identification label or marking 62 on the cover component 70 of the vessel carrier 100.

FIG. 6 shows an example of transport mechanism 170 for moving the vessel carrier 100 in the automated laboratory system 200. The transport mechanism 170 can comprise a moving pin 171, e.g. mounted on a head of a one-dimensional or two-dimensional translation mechanism, for engaging with the engagement element 31 at the bottom side 30 of the vessel carrier 100, and moving the vessel carrier 100 within the automated laboratory system 200, e.g. from an input position to an aspiration position and from the aspiration position to an output position.

It is noted that terms like “preferably,” “commonly,” and “typically” are not utilized herein to limit the scope of the claimed embodiments or to imply that certain features are critical, essential, or even important to the structure or function of the claimed embodiments. Rather, these terms are merely intended to highlight alternative or additional features that may or may not be utilized in a particular embodiment of the present disclosure.

Having described the present disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

We claim:

1. A vessel carrier for use in connection to an automated laboratory system, the vessel carrier comprising:
an upper side comprising one or more openings for introducing a respective number of vessels;
a bottom side;
a middle body portion between the upper side and the bottom side, the middle body portion comprising one or more vessel holding positions comprising walls for holding a respective number of vessels and extending respectively in correspondence to the one or more openings on the upper side into the middle body portion; and
a two-component structure comprising,
a core component made of an electrically conductive material, the core component comprising at least part of the bottom side and the walls of the one or more vessel holding positions, and
a cover component that covers at least part of the core component and is made of a material that is different or has different properties with respect to the material of the core component and is customizable for identification and/or handling.

2. The vessel carrier of claim 1, wherein the core component is formed as a first piece and the cover component is formed as a separate second piece designed to form fit with the first piece to be separable from the first piece and to be replaceable or exchangeable.

3. The vessel carrier of claim 1, wherein the core component is formed as a first piece and the cover component is injection molded on top of the first piece to form an inseparable two-component structure together with the first piece.

4. The vessel carrier according to claim 1, wherein the electrically conductive material forming the core component is metal.

5. The vessel carrier according to claim 1, wherein the electrically conductive material forming the core component is an electrically conductive polymeric material.

6. The vessel carrier according to claim 5, wherein the electrically conductive polymeric material comprises a mixture of polypropylene and carbon fiber at a dosage of at least 70%.

7. The vessel carrier according to claim 5, wherein the electrically conductive polymeric material has a surface electric resistance of less than 4000 Ohm.

8. The vessel carrier according to claim 5, wherein the electrically conductive polymeric material has a surface electric resistance of less than 2000 Ohm.

9. The vessel carrier according to claim 1, wherein the cover component is made of a non-electrically-conductive polymer.

10. The vessel carrier according to claim 1, wherein the cover component comprises any one or more of a carrier identification label or marking, vessel position label or marking, carrier-type label or marking.

11. The vessel carrier according to claim 10, wherein the marking is a laser marking.

12. The vessel carrier according to claim 1, wherein the bottom side comprises an engagement element for engaging with a transport element of an automated laboratory system for moving the vessel carrier.

13. The vessel carrier according to claim 1, wherein the core component is magnetic or paramagnetic for enabling magnetic transport of the vessel carrier.

14. An automated laboratory system, the automated laboratory system comprising:
an analyzer for analyzing biological samples; and
a vessel carrier according to claim 1 carrying one or more vessels in contact with the walls of the vessel holding positions of the core component, the vessels containing test fluids such as biological samples to be analyzed or reagents to be used with the biological samples or mixtures of biological sample and reagents.

15. The automated laboratory system according to claim 14, further comprising,
at least one aspiration probe having an electric capacitance;
a positioning mechanism adapted for moving the aspiration probe relative to the test fluid in the vessel;
a voltage source for charging the aspiration probe;
an electric drain in contact with the bottom side of the vessel carrier for discharging the aspiration probe when the aspiration probe contacts the test fluid by generating a discharging current passing from the aspiration probe to the electric drain though the test fluid, the vessel containing the test fluid and the core component of the vessel carrier;
an electric circuitry connected to the aspiration probe adapted to measure the discharging current; and
a controller configured to move the aspiration probe into the test fluid and to determine a level of the test fluid in the vessel based on the measured current.

16. The automated laboratory system according to claim 14, further comprising,
a reading device for reading an identification label or marking on the cover component of the vessel carrier.

17. The automated laboratory system according to claim 14, further comprising,
a transportation system for moving the vessel carrier.
